(19) United States
(12) Patent Application Publication
(10) Pub. No.: US 2026/0120223 A1
(43) Pub. Date: Apr. 30, 2026

(54) DEVICES AND METHODS FOR DIGITAL WATERMARKING

(71) Applicant: HUAWEI TECHNOLOGIES CO., LTD., Shenzhen (CN)

(72) Inventors: Gabriele GELARDI, Munich (DE); Theo DIMITRAKOS, Munich (DE)

(21) Appl. No.: 19/007,145

(22) Filed: Dec. 31, 2024

Related U.S. Application Data
(63) Continuation of application No. PCT/EP2022/068658, filed on Jul. 6, 2022.

(51) Int. Cl. G06T 1/00; H04N 19/46; H04N 21/8358

(52) U.S. Cl. CPC G06T 1/0021; H04N 19/46; H04N 21/8358; G06T 2201/0053

(57) ABSTRACT

An apparatus is disclosed for encoding a message including a plurality of message bits in a digital watermark frame for a video stream with a plurality of frames. The apparatus comprises a processing circuitry configured to generate a first subframe of the digital watermark frame, wherein the first subframe of the digital watermark frame is a result of an elementwise XOR operation between a first matrix of a pair of matrices of random bits and a matrix of the plurality of message bits. The processing circuitry is further configured to generate a second subframe of the digital watermark frame, wherein the second subframe of the digital watermark frame is a result of an elementwise XOR operation between a second matrix of the pair of matrices of random bits and the matrix of the plurality of message bits.

### CROSS-REFERENCE TO RELATED APPLICATIONS

This application is a continuation of International Application No. PCT/EP2022/068658, filed on Jul. 6, 2022, the disclosure of which is hereby incorporated by reference in its entirety.

### TECHNICAL FIELD

The present application relates to data processing. More specifically, the present application relates to devices and methods for digital watermarking of a video stream.

### BACKGROUND

With the increase in the use and distribution of digital multimedia data, content protection becomes increasingly important to avoid unrestricted duplication and dissemination of copyrighted materials. Digital watermark technology has emerged as a method complementary to encryption for content protection of copyrighted materials. Digital watermarking techniques embed a secret imperceptible signal, a watermark, into the original content. It usually remains present with the original content and survives transformation, conversion and transcoding.

Conventional blind video watermarking scheme are not able to obtain pre-screening watermark information during the decoding process. Decoding the watermark message from the video and use some sort of error-detection code (i.e. CRC, Hash functions, etc.) in order to binary validate the extracted message, is the only available operation.

A “camcorded” video is a video that has been recorded using a camera recording a video being played on a screen monitor. These types of videos necessitate a realignment process in order to extract the watermark. This can be a very challenging scenario for a technique where no preliminary feedback is available since it is not possible to discriminate between a bad alignment and too damaged watermark.

A robust watermarking scheme should be capable of changing the watermark structure after a certain number of frames avoiding that an attacker could average down the watermark structure by collecting a sufficient number of frame and easily remove the watermark from the video. Applying a structure rotation of the watermark during the encoding process requires the decoder to recognize the different stages of the watermark structure and threat it accordingly in order to decode the watermark. This poses a synchronization problem since the decoder should be able to synchronize with the different stages of the watermark structure and be resilient to a tampering attack, i.e. frame dropping, swapping, and the like.

Conventional watermarking approaches try to address the above issues by reserve a certain amount of space from the total embeddable space for embedding a fixed message (also referred to as tag). These conventional approaches have the following disadvantages. Firstly, the space used by the tag cannot be used for the message, so the total embeddable space is reduced. Secondly, the tag may be covered or become damaged, leaving a good percentage of the video visible but losing the possibility to align the frame. Thirdly, the tag may not be able to provide a faithful pre-screening status of the frame since it is usually quite small (an increase of the tag size would lead to a reduction of the available size for the message).

### SUMMARY

It is an object of the embodiments of the application to provide improved devices and methods for digital watermarking.

The foregoing and other objects are achieved by the subject matter of the independent claims. Further implementation forms are apparent from the dependent claims, the description and the figures.

Embodiments disclosed herein provide a digital watermarking technique capable of revealing information about the status of the digital watermark without fully decoding the digital watermark and without knowing its content. Thus, this technique can be regarded as a Zero knowledge proof, since it allows to assess the integrity, i.e. “healthiness” of the message without knowing the message itself. Embodiments disclosed herein provide a new approach to pre-processing the message before the actual embedding process. Thus, embodiments disclosed herein allow enhancing existing spatial watermark techniques.

According to a first aspect an apparatus (also referred to as encoding apparatus) is provided for encoding a message including a plurality of message bits in a digital watermark frame for a video stream with a plurality of frames. The apparatus comprises a processing circuitry configured to generate a first subframe (also referred to as a first tile) of the digital watermark frame, wherein the first subframe of the digital watermark frame is the result of an elementwise, i.e. element-by-element XOR operation between a first matrix of a pair of matrices of random bits and a matrix of the plurality of message bits. Moreover, the processing circuitry is configured to generate a second subframe (also referred to as a second tile) of the digital watermark frame, wherein the second subframe of the digital watermark frame is the result of an elementwise, i.e. element-by-element XOR operation between a second matrix of the pair of matrices of random bits and the matrix of the plurality of message bits. Thus, an improved encoding apparatus for digital watermarking is provided.

In an embodiment, the processing circuitry is further configured to embed the digital watermark frame in one or more frames of the plurality of frames of the video stream.

In an embodiment, the processing circuitry is further configured to arrange the first subframe and/or the second subframe at more than one position of the digital watermark frame.

In an embodiment, the processing circuitry is configured to:
generate a first subframe of at least one further digital watermark frame, wherein the first subframe of the at least one further digital watermark frame is the result of an elementwise, i.e. element-by-element XOR operation between a first matrix of a further pair of matrices of random bits and the matrix of the plurality of message bits; and
generate a second subframe of the at least one further digital watermark frame, wherein the second subframe of the at least one further digital watermark frame is the result of a elementwise, i.e. element-by-element XOR operation between a second matrix of the further pair of matrices of random bits and the matrix of the plurality of message bits.

In an embodiment, the processing circuitry is further configured to embed the further digital watermark frame in one or more further frames of the plurality of frames of the video stream.

In an embodiment, the processing circuitry is further configured to store in a data structure the pair of matrices of random bits together with a key matrix and/or data for obtaining or generating the pair of matrices of random bits and the key matrix, wherein the key matrix is the XOR product of the first matrix of random bits and the second matrix of random bits.

In an embodiment, the processing circuitry is further configured to generate the pair of matrices of random bits, including the first matrix of random bits and the second matrix of random bits.

In an embodiment, the processing circuitry is further configured to generate the matrix of the plurality of message bits.

According to a second aspect a method is provided for encoding a message including a plurality of message bits in a digital watermark frame for a video stream with a plurality of frames. The method comprises:
generating a first subframe of the digital watermark frame, wherein the first subframe of the digital watermark frame is the result of an elementwise XOR operation between a first matrix of a pair of matrices of random bits and a matrix of the plurality of message bits; and
generating a second subframe of the digital watermark frame, wherein the second subframe of the digital watermark frame is the result of an elementwise XOR operation between a second matrix of the pair of matrices of random bits and the matrix of the plurality of message bits.

The encoding method according to the second aspect can be performed by the encoding apparatus according to the first aspect. Thus, further features of the encoding method according to the second aspect result directly from the functionality of the encoding apparatus according to the first aspect and its different implementation forms described above and below.

According to a third aspect an apparatus (also referred to as decoding apparatus) is provided for retrieving, i.e. extracting a message including a plurality of message bits from a digital watermark frame in a video stream with a plurality of frames. The apparatus comprises a processing circuitry configured to extract a digital watermark frame from at least one frame of the plurality of frames of the video stream. Moreover, the processing circuitry is configured to perform an elementwise XOR operation between a first subframe and a second subframe of the digital watermark for determining a key matrix. The processing circuitry is further configured to determine a first matrix and a second matrix of a pair of matrices of random bits based on the key matrix, wherein the key matrix is the elementwise XOR product of the first matrix of random bits and the second matrix. Moreover, the processing circuitry is configured to perform an elementwise XOR operation between the first matrix of the pair of matrices of random bits and the first subframe of the digital watermark frame for obtaining a first plurality of candidate message bits. The processing circuitry is further configured to perform an elementwise XOR operation between the second matrix of the pair of matrices of random bits and the second subframe of the digital watermark frame for obtaining a second plurality of candidate message bits. Thus, an improved decoding apparatus for digital watermarking is provided.

In an embodiment, the processing circuitry is configured to retrieve the message including the plurality of message bits based on the first plurality of candidate message bits and the second plurality of candidate message bits, for instance, by performing an averaging operation of the first plurality of candidate message bits and the second plurality of candidate message bits.

In an embodiment, the processing circuitry is further configured to:
extract a further digital watermark frame from at least one further frame of the plurality of frames of the video stream;
perform an elementwise XOR operation between a first subframe and a second subframe of the further digital watermark frame for determining a further key matrix;
determine a further first matrix and a further second matrix of a further pair of matrices of random bits based on the further key matrix, wherein the further key matrix is an elementwise XOR product of the further first matrix and the further second matrix;
perform an elementwise XOR operation between the further first matrix of the further pair of matrices of random bits and the first subframe of the further digital watermark frame for obtaining a further first plurality of candidate message bits; and
perform an elementwise XOR operation between the second matrix of the further pair of matrices of random bits and the second subframe of the further digital watermark frame for obtaining a further second plurality of candidate message bits.

In an embodiment, for determining the pair of matrices of random bits based on the key matrix the processing circuitry is further configured to retrieve based on the key matrix from a data structure the pair of matrices of random bits and/or data for obtaining or generating the pair of matrices of random bits.

In an embodiment, for obtaining the key matrix the processing circuitry is configured to:
perform the elementwise XOR operation between the first subframe and the second subframe of the digital watermark for obtaining a candidate key matrix; and
determine the key matrix based on the data structure by determining the key matrix defined by the data structure having the smallest distance, in particular the smallest Hamming distance, to the candidate key matrix.

According to a fourth aspect a method is provided for retrieving a message including a plurality of message bits from a digital watermark frame in a video stream with a plurality of frames. The method comprises:
extracting a digital watermark frame from at least one frame of the plurality of frames of the video stream;
performing an elementwise XOR operation between a first subframe and a second subframe of the digital watermark for determining a key matrix;
determining a first matrix and a second matrix of a pair of matrices of random bits based on the key matrix, wherein the key matrix is the elementwise XOR product of the first matrix of random bits and the second matrix;
performing an elementwise XOR operation between the first matrix of the pair of matrices of random bits and the first subframe of the digital watermark frame for obtaining a first plurality of candidate message bits; and
performing an elementwise XOR operation between the second matrix of the pair of matrices of random bits and the second subframe of the digital watermark frame for obtaining a second plurality of candidate message bits.

The decoding method according to the fourth aspect can be performed by the decoding apparatus according to the third aspect. Thus, further features of the decoding method according to the fourth aspect result directly from the functionality of the decoding apparatus according to the third aspect and its different implementation forms described above and below.

According to a fifth aspect a computer program or a computer program product is provided, comprising a computer-readable storage medium carrying program code which causes a computer or a processor to perform the method according to the second aspect or the method according to the fourth aspect when the program code is executed by the computer or the processor.

The different aspects of the application can be implemented in software and/or hardware.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the application are described in more detail with reference to the attached figures and drawings, in which:

FIG. 1 is a schematic diagram illustrating an encoding apparatus according to an embodiment for encoding a message in a digital watermark frame for a video stream and a decoding apparatus according to an embodiment for retrieving the message from the digital watermark frame in the video stream;

FIG. 2 is a schematic diagram illustrating frames of a video stream with an embedded digital watermark;

FIG. 3 is a schematic diagram illustrating an elementwise XOR operation between a pair of matrices of random bits for generating a key matrix as used by an encoding apparatus according to an embodiment and a decoding apparatus according to an embodiment;

FIG. 4 is a schematic diagram illustrating an arrangement of a message as used by an encoding apparatus according to an embodiment;

FIG. 5 is a schematic diagram illustrating a digital watermark frame generated by the encoding apparatus according to an embodiment;

FIG. 6 is a flow diagram illustrating a computer-implemented method according to an embodiment for encoding a message in a digital watermark frame for a video stream; and

FIG. 7 is a flow diagram illustrating a computer-implemented method according to an embodiment for retrieving a message from a digital watermark frame in a video stream.

In the following identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the application or specific aspects in which embodiments of the present application may be used. It is understood that embodiments of the application may be used in other aspects and comprise structural or logical changes not depicted in the figures. The following detailed description, therefore, is not to be taken in a limiting sense, and the scope of the present application is defined by the appended claims.

For instance, it is to be understood that a disclosure in connection with a described method may also hold true for a corresponding device or system configured to perform the method and vice versa. For example, if one or a plurality of specific method operations are described, a corresponding device may include one or a plurality of units, e.g. functional units, to perform the described one or plurality of method operations (e.g. one unit performing the one or plurality of operations, or a plurality of units each performing one or more of the plurality of operations), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of operations each performing the functionality of one or more of the plurality of units), even if such one or plurality of operations are not explicitly described or illustrated in the figures. Further, it is understood that the features of the various exemplary embodiments and/or aspects described herein may be combined with each other, unless specifically noted otherwise.

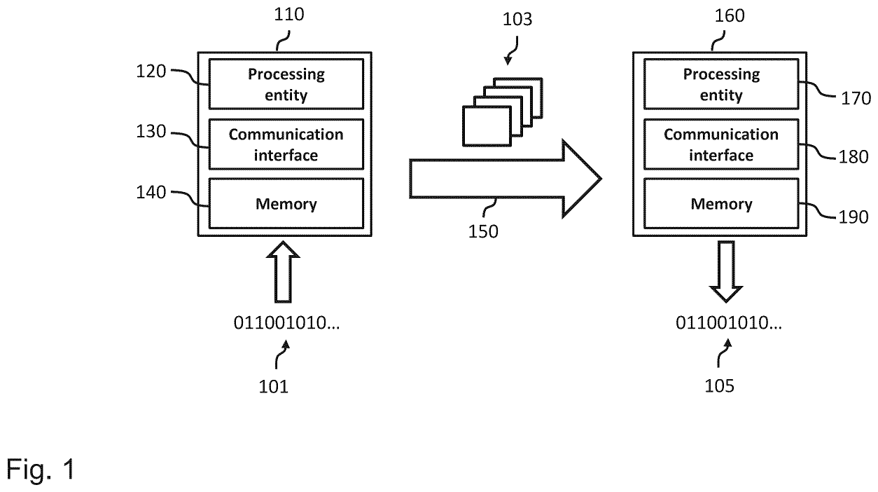

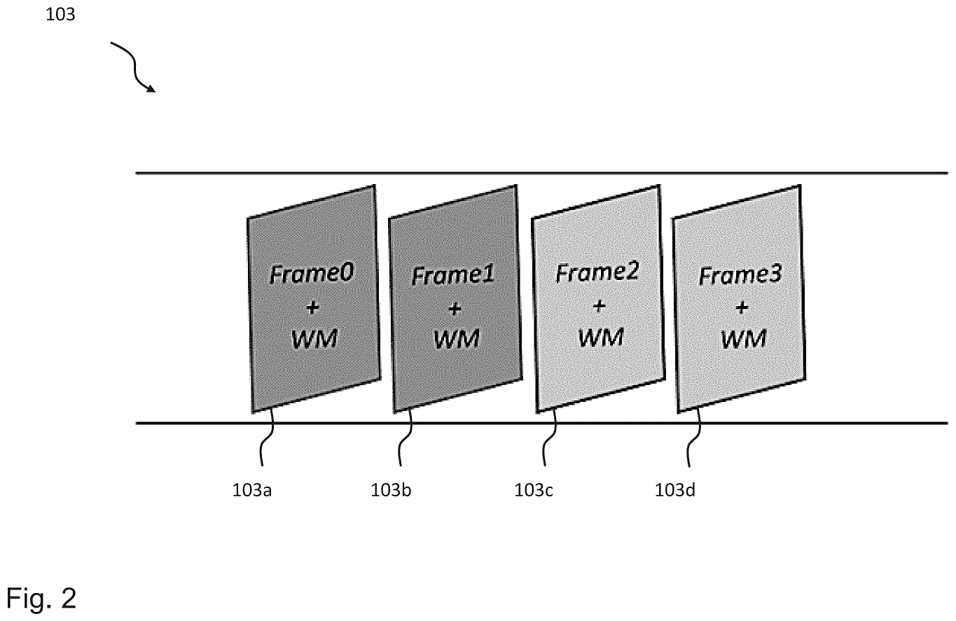

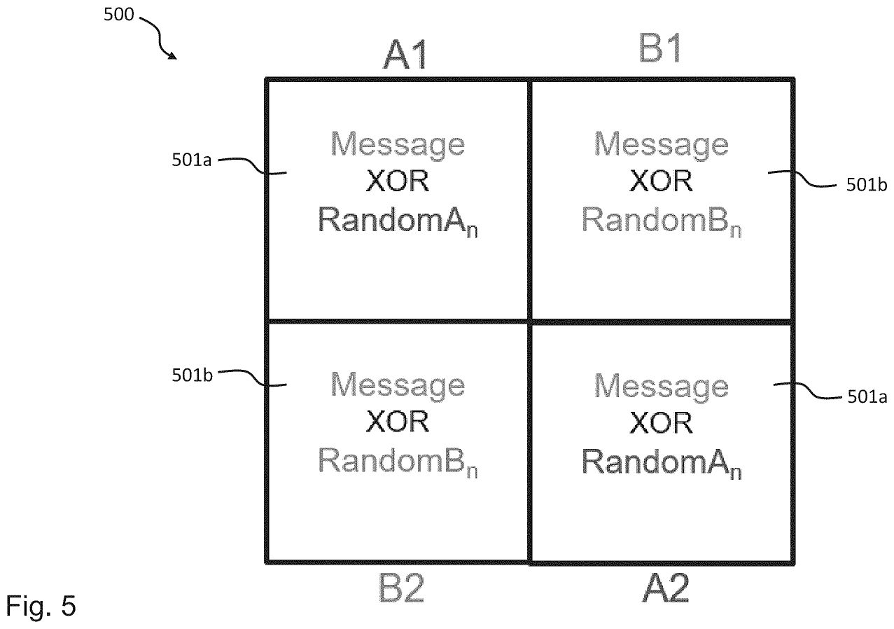

FIG. 1 is a schematic diagram illustrating an encoding apparatus 110 according to an embodiment for encoding a message including a plurality of message bits 101 in a digital watermark frame (for instance the digital watermark frame 501 shown in FIG. 5) for a video stream 103 including a plurality of video frames 103a-d (shown in FIG. 2) and a decoding apparatus 160 according to an embodiment for retrieving the message including a plurality of message bits 105 from the digital watermark frame 501 within the video stream 103. FIG. 2 is a schematic diagram illustrating a plurality of exemplary frames 103a-d of a video stream 103 with an embedded digital watermark. The encoding apparatus 110 and/or the decoding apparatus 160 may be a data processing apparatus, such as a server, a desktop computer, a laptop computer, a tablet computer or another device having the computational resources for implementing the embodiments disclosed herein.

As illustrated in FIG. 1, the encoding apparatus 110 comprises a processing circuitry 120, such as one or more processors 120 for processing data. The processing circuitry 120 of the encoding apparatus 110 may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. Moreover, the encoding apparatus 110 may comprise a communication interface 130 for wired and/or wireless communication, for instance, with the decoding apparatus 160. The encoding apparatus 110 may further comprise a memory 140 for storing and retrieving data. The memory 140 of the encoding apparatus 110 may store executable program code which, when executed by the processing circuitry 120, causes the encoding apparatus 110 to perform the functions and methods described herein.

Likewise, the decoding apparatus 160 comprises a processing circuitry 170, such as one or more processors 170 for processing data. The processing circuitry 170 of the decoding apparatus 160 may be implemented in hardware and/or software. The hardware may comprise digital circuitry, or both analog and digital circuitry. Digital circuitry may comprise components such as application-specific integrated circuits (ASICs), field-programmable arrays (FPGAs), digital signal processors (DSPs), or general-purpose processors. Moreover, the decoding apparatus 160 may comprise a communication interface 180 for wired and/or wireless communication, for instance, with the encoding apparatus 110. The decoding apparatus 160 may further comprise a memory 190 for storing and retrieving data. The memory 190 of the decoding apparatus 160 may store executable program code which, when executed by the processing circuitry 170, causes the decoding apparatus 160 to perform the functions and methods described herein.

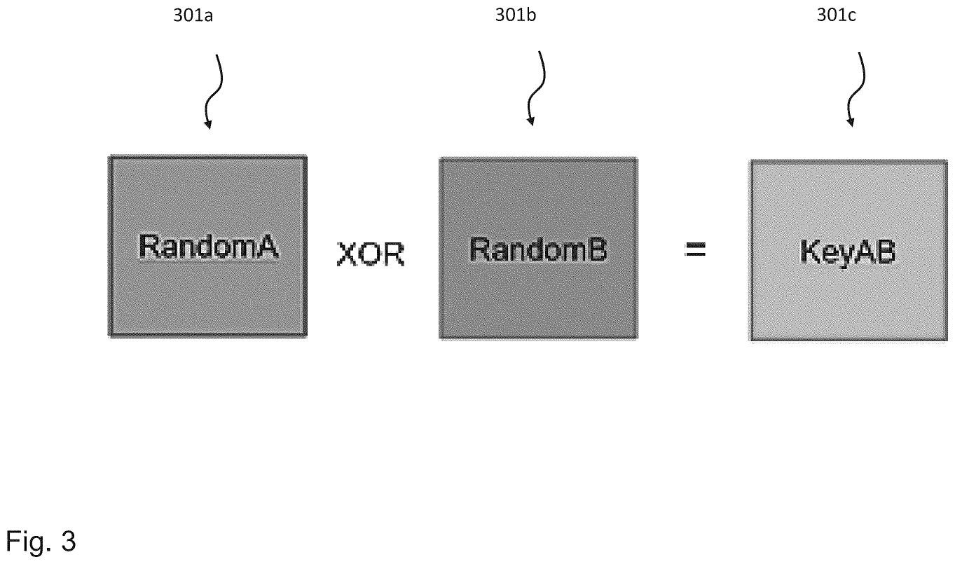

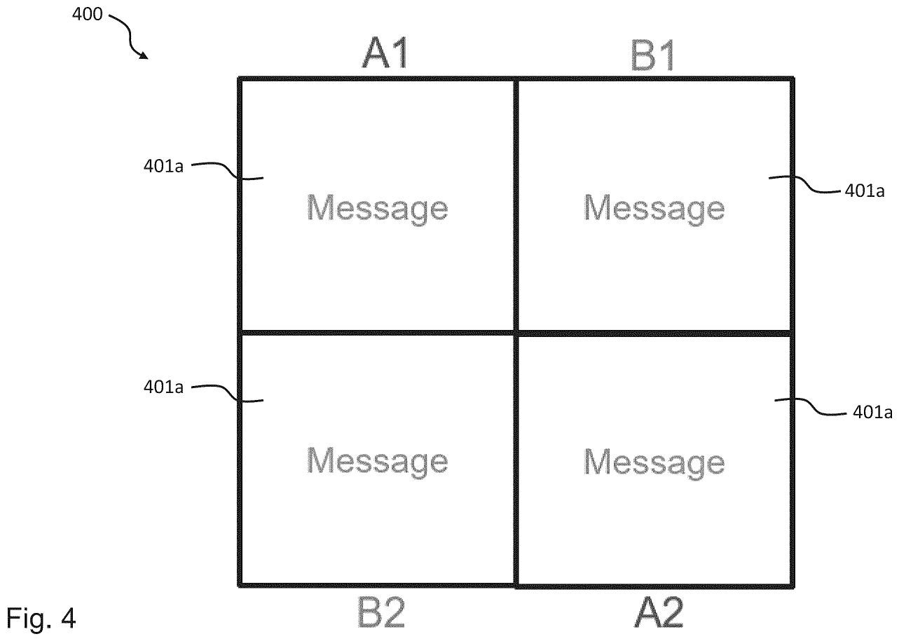

As will be described in more detail in the following under further reference to FIGS. 3 to 5, the processing circuitry 120 of the encoding apparatus 110 is configured to generate a first subframe 501a (illustrated as “Message XOR RandomAn” in FIG. 5) of the digital watermark frame 500, wherein the first subframe 501a of the digital watermark frame 500 is the result of an elementwise XOR operation between a first matrix 301a (illustrated as “RandomA” in FIG. 3) of a pair of matrices of random bits and a matrix 401a (illustrated as “Message” in FIG. 4) of the plurality of message bits 101. Moreover, the processing circuitry 120 of the encoding apparatus 110 is configured to perform the same operation with a second matrix 301b (illustrated as “RandomB” in FIG. 3) of the pair of matrices of random bits. In an embodiment, the processing circuitry 120 of the encoding apparatus 110 is further configured to generate a second subframe 501b (referred to as “Message XOR RandomBn” in FIG. 5) of the digital watermark frame 501 as the result of an elementwise XOR operation between the second matrix 301b (illustrated as “RandomB” in FIG. 3) of the pair of matrices of random bits and the matrix 401a (illustrated as “Message” in FIG. 4) of the plurality of message bits 101. As illustrated in FIG. 3, the elementwise XOR product of the first matrix 301a, i.e. “RandomA” and the second matrix 301b, i.e. “RandomB” of the pair of matrices of random bits is a key matrix 301c (referred to as “KeyAB” in FIG. 3), which will be described in more detail below. As used herein, the elementwise XOR product (also referred to as XOR operation) is the XOR product element-by-element.

As illustrated in the embodiment shown in FIG. 5, the processing circuitry 120 of the encoding apparatus 110 may be configured to arrange the first subframe 501a and/or the second subframe 501b generated in the way described above at more than one position of the digital watermark frame 501. For instance, in the exemplary embodiment shown in FIG. 5, the first subframe 501a is arranged in both the upper left and the lower right quadrant of the digital watermark frame 500, while the second subframe 501b is arranged in both the upper right and lower left quadrant of the digital watermark frame 500.

Once the processing circuitry 120 of the encoding apparatus 110 has generated, for instance, the digital watermark frame 500 illustrated in FIG. 5, the processing circuitry may further embed the digital watermark frame 500 in one or more frames of the plurality of frames 103a-d of the video stream 103. In an embodiment, the processing circuitry 120 of the encoding apparatus 110 may implement conventional watermark embedding techniques.

In an embodiment, the processing circuitry 120 of the encoding apparatus 110 is not only configured to generate a single digital watermark frame 500 in the way described above, but a plurality of digital watermark frames like the frame 500 using different pairs of random matrices An and Bn. In an embodiment, the processing circuitry 120 of the encoding apparatus 110 is configured to generate a first subframe and a second subframe of at least one further digital watermark frame, wherein the first subframe of the at least one further digital watermark frame is the result of an elementwise XOR operation between a first matrix of a further pair of matrices of random bits and the matrix 401a of the plurality of message bits 101 and wherein the second subframe of the at least one further digital watermark frame is the result of an elementwise XOR operation between a second matrix of the further pair of matrices of random bits and the matrix 401a of the plurality of message bits 101. These one or more further digital watermark frames may be embedded in one or more further frames of the plurality of frames 103a-d of the video stream 103.

In an embodiment, the processing circuitry 120 of the encoding apparatus 110 is configured to store the different pairs of matrices of random bits, such as the pair of matrices 301a, b, used for generating the plurality of different digital watermark frames, such as the digital watermark frame 500, together with the corresponding key matrix 301c in a data structure (also referred to as key-value data structure) in the memory 140. As already described above, the respective key matrix 301c is the XOR product of the first matrix 301a and the second matrix 301b of the respective pair of matrices of random bits. Alternatively, the processing circuitry 120 of the encoding apparatus 110 may be configured to store data, such as a plurality of seed values or pointers, for obtaining or generating the plurality of pairs of matrices and the respective the key matrix. In an embodiment, the encoding apparatus 110 is configured to provide this data structure to the decoding apparatus 160, for instance, via the communication interface 130.

For retrieving the message including the plurality of message bits 105 from the digital watermark frame 500 embedded in one or more of the plurality of frames 103a-d of the video stream 103 the processing circuitry 170 of the decoding apparatus 160 is configured to extract the digital watermark frame 500 from at least one frame of the plurality of frames 103a-d of the video stream 103.

The processing circuitry 170 of the decoding apparatus 160 is further configured to perform an elementwise XOR operation between the first subframe 501a (referred to as “Message XOR RandomAn” in FIG. 5) and the second subframe 501b (referred to as “Message XOR RandomBn” in FIG. 5) of the retrieved digital watermark frame 500. As will be appreciated, due to the properties of the XOR operation this will result in the XOR product of the product of the first matrix 301a and the second matrix 301b of the respective pair of matrices of random bits, which, as already described above, is the key matrix 301c is the XOR product of the first matrix 301a and the second matrix 301b of the respective pair of matrices of random bits. In other words, the processing circuitry 170 of the decoding apparatus 160 is configured to determine the first matrix 301a and the second matrix 301b of the pair of matrices of random bits based on the key matrix 301c.

The processing circuitry 170 of the decoding apparatus 160 is further configured to perform an elementwise XOR operation between the first matrix 301a of the pair of matrices of random bits (determined based on the key matrix 301c) and the first subframe 501a of the retrieved digital watermark frame 500. As will be appreciated, due to the properties of the XOR operation this will result in a first plurality of candidate message bits, which may differ, for instance, due to noise from the original plurality of message bits 101.

The processing circuitry 170 of the decoding apparatus 160 is further configured to perform an elementwise XOR operation between the second matrix 301b of the pair of matrices of random bits (determined based on the key matrix 301c) and the second subframe 501b of the retrieved digital watermark frame 500 for obtaining a second plurality of candidate message bits. Again, due to the properties of the XOR operation this will result in a second plurality of candidate message bits, which may differ, for instance, due to noise from the original plurality of message bits 101 and the first plurality of candidate message bits.

In an embodiment, the processing circuitry 170 of the decoding apparatus 160 is configured to retrieve the message including the plurality of message bits 105 (which ideally are identical to the plurality of message bits 101 of the original message] based on the first plurality of candidate message bits and the second plurality of candidate message bits, for instance, using an averaging scheme.

As in the case of the encoding apparatus 110 described above, the decoding apparatus 160 may retrieve a plurality of digital watermark frames from the frames 103a-d of the video stream and process these digital watermark frames in the way described above. In an embodiment, the processing circuitry 170 of the decoding apparatus 160 is further configured to extract a further digital watermark frame from at least one further frame of the plurality of frames 103a-d of the video stream 103 and to perform an elementwise XOR operation between a first subframe and a second subframe of the further digital watermark frame for determining a further key matrix. The processing circuitry 160 may be further configured to determine a further first matrix and a further second matrix of a further pair of matrices of random bits based on the further key matrix, wherein the further key matrix is an elementwise XOR product of the further first matrix and the further second matrix. Moreover, the processing circuitry 160 may be configured to perform an elementwise XOR operation between the further first matrix of the further pair of matrices of random bits and the first subframe of the further digital watermark frame for obtaining a further first plurality of candidate message bits and to perform an elementwise XOR operation between the second matrix of the further pair of matrices of random bits and the second subframe of the further digital watermark frame for obtaining a further second plurality of candidate message bits.

For determining the pair of matrices 301a, b of random bits based on the key matrix 301c the processing circuitry 170 may be further configured to retrieve based on the key matrix 301c the pair of matrices 301a, b of random bits from the data structure generated by the encoding apparatus 110, as described above. Alternatively, the processing circuitry 170 may obtain data from the encoding apparatus 110, such as a seed value for a random number generator or a pointer, for obtaining or generating the data structure including the pair of matrices 301a, b of random bits and the associated key matric 301c.

For obtaining the respective key matrix the processing circuitry 170 of the decoding apparatus 160 may be configured to perform the elementwise XOR operation between the first subframe 501a and the second subframe 501b of the digital watermark frame 500 for a plurality of different digital watermark frames obtaining a plurality of candidate key matrices and to determine the actual key matrix 301c based on the data structure by determining the key matrix 301c defined by the data structure having the smallest distance, for instance, Hamming distance to the candidate key matrix. In other words, the processing circuitry 170 of the decoding apparatus 160 will select that key matrix (and the corresponding matrix pair) that is closest to the candidate key matrix.

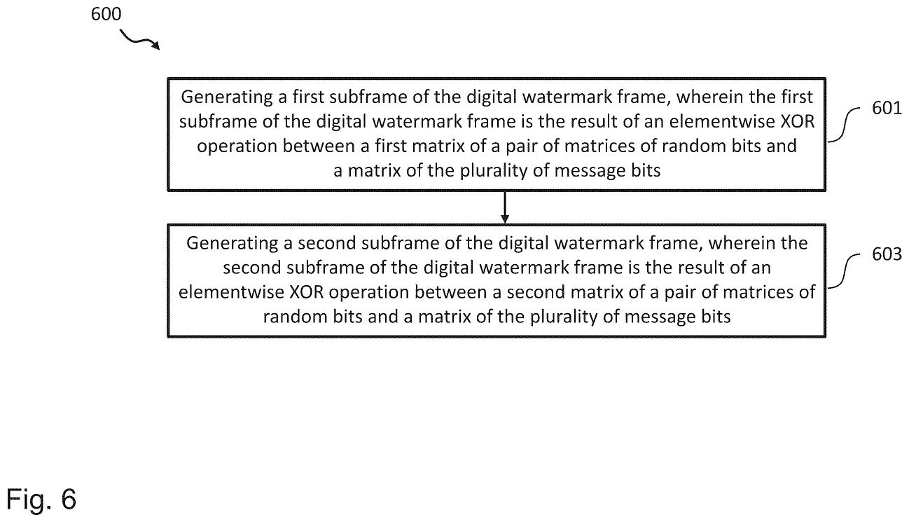

FIG. 6 is a flow diagram illustrating an embodiment of a computer-implemented method 600 for encoding a message including the plurality of message bits 101 in the digital watermark frame 500 for the video stream 103 with the plurality of exemplary frames 103a-d. The method 600 comprises an operation 601 of generating a first subframe 501a of the digital watermark frame 500, wherein, as already described above, the first subframe 501a of the digital watermark frame 500 is the result of an elementwise XOR operation between the first matrix 301a of the pair of matrices of random bits and the matrix 401a of the plurality of message bits 101. Moreover, the method 600 comprises an operation 603 of generating a second subframe 501b of the digital watermark frame 500, wherein the second subframe 501b of the digital watermark frame 500 is the result of an elementwise XOR operation between the second matrix 301b of the pair of matrices of random bits and the matrix 401a of the plurality of message bits 101.

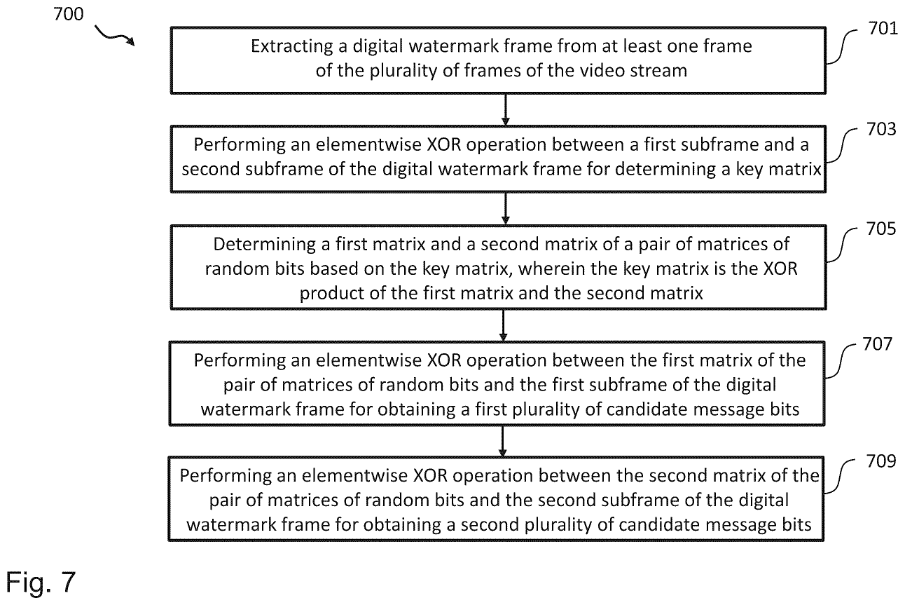

FIG. 7 is a flow diagram illustrating an embodiment of a computer-implemented method 700 for retrieving, i.e. decoding a message including the plurality of message bits 105 from the digital watermark frame 500 of the video stream 103 with the plurality of frames 103a-d. The method 700 comprises an operation 701 of extracting the digital watermark frame 500 from at least one frame of the plurality of frames 103a-d of the video stream 103. Moreover, the method 700 comprises an operation 703 of performing an elementwise XOR operation between the first subframe 501a and the second subframe 501b of the digital watermark frame 500 for determining the key matrix 301c, as already described above The method 700 further comprises an operation 705 of determining the first matrix 301a and the second matrix 301b of the pair of matrices of random bits based on the key matrix 301c, wherein the key matrix 301c is the elementwise XOR product of the first matrix 301a and the second matrix 301b. Moreover, the method 700 comprises an operation 707 of performing an elementwise XOR operation between the first matrix 301a of the pair of matrices of random bits and the first subframe 501a of the digital watermark frame 500 for obtaining a first plurality of candidate message bits. The method 700 further comprises an operation 709 of performing an elementwise XOR operation between the second matrix 301b of the pair of matrices of random bits and the second subframe 501b of the digital watermark frame 500 for obtaining a second plurality of candidate message bits.

The person skilled in the art will understand that the “blocks” (“units”) of the various figures (method and apparatus) represent or describe functionalities of embodiments of the application (rather than necessarily individual “units” in hardware or software) and thus describe equally functions or features of apparatus embodiments as well as method embodiments (unit=operation).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the application may be integrated into one processing unit, or each of the units may exist alone physically, or two or more units are integrated into one unit.

1. An apparatus for encoding a message including a plurality of message bits in a digital watermark frame for a video stream with a plurality of frames, wherein the apparatus comprises a processing circuitry configured to:
generate a first subframe of the digital watermark frame, wherein the first subframe of the digital watermark frame is a result of an elementwise XOR operation between a first matrix of a pair of matrices of random bits and a matrix of the plurality of message bits in the digital watermark frame; and
generate a second subframe of the digital watermark frame, wherein the second subframe of the digital watermark frame is a result of an elementwise XOR operation between a second matrix of the pair of matrices of random bits and the matrix of the plurality of message bits in the digital watermark frame.

2. The apparatus of claim 1, wherein the processing circuitry is further configured to embed the digital watermark frame in one or more frames of the plurality of frames of the video stream.

3. The apparatus of claim 1, wherein the processing circuitry is further configured to arrange at least one of the first subframe or the second subframe at more than one position of the digital watermark frame.

4. The apparatus of claim 1, wherein the processing circuitry is further configured to:
generate a first subframe of at least one further digital watermark frame, wherein the first subframe of the at least one further digital watermark frame is a result of an elementwise XOR operation between a first matrix of a further pair of matrices of random bits and the matrix of the plurality of message bits in the digital watermark frame; and
generate a second subframe of the at least one further digital watermark frame, wherein the second subframe of the at least one further digital watermark frame is a result of an elementwise XOR operation between a second matrix of the further pair of matrices of random bits and the matrix of the plurality of message bits in the digital watermark frame.

5. The apparatus of claim 4, wherein the processing circuitry is further configured to embed the at least one further digital watermark frame in one or more further frames of the plurality of frames of the video stream.

6. The apparatus of claim 4, wherein the processing circuitry is further configured to store in a data structure the pair of matrices of random bits together with a key matrix, or data for obtaining or generating the pair of matrices of random bits and the key matrix, wherein the key matrix is an elementwise XOR product of the first matrix of the pair of matrices of random bits and the second matrix of the pair of matrices of random bits.

7. The apparatus of claim 1, wherein the processing circuitry is further configured to generate the pair of matrices of random bits, including the first matrix of the pair of matrices of random bits and the second matrix of the pair of matrices of random bits.

8. The apparatus of claim 1, wherein the processing circuitry is further configured to generate the matrix of the plurality of message bits in the digital watermark frame.

9. A method for encoding a message including a plurality of message bits in a digital watermark frame for a video stream with a plurality of frames, wherein the method comprises:
generating a first subframe of the digital watermark frame, wherein the first subframe of the digital watermark frame is a result of an elementwise XOR operation between a first matrix of a pair of matrices of random bits and a matrix of the plurality of message bits in the digital watermark frame; and
generating a second subframe of the digital watermark frame, wherein the second subframe of the digital watermark frame is a result of an elementwise XOR operation between a second matrix of the pair of matrices of random bits and the matrix of the plurality of message bits in the digital watermark frame.

10. An apparatus for retrieving a message including a plurality of message bits from a digital watermark frame in a video stream with a plurality of frames, wherein the apparatus comprises a processing circuitry configured to:
extract a digital watermark frame from at least one frame of the plurality of frames of the video stream;
perform an elementwise XOR operation between a first subframe of the digital watermark frame and a second subframe of the digital watermark frame, to determine a key matrix;
determine a first matrix of a pair of matrices of random bits and a second matrix of the pair of matrices of random bits based on the key matrix, wherein the key matrix is an elementwise XOR product of the first matrix and the second matrix;
perform an elementwise XOR operation between the first matrix of the pair of matrices of random bits and the first subframe of the digital watermark frame, to obtain a first plurality of candidate message bits; and
perform an elementwise XOR operation between the second matrix of the pair of matrices of random bits and the second subframe of the digital watermark frame, to obtain a second plurality of candidate message bits.

11. The apparatus of claim 10, wherein the processing circuitry is further configured to retrieve the message including the plurality of message bits based on the first plurality of candidate message bits and the second plurality of candidate message bits.

12. The apparatus of claim 10, wherein the processing circuitry is further configured to:
extract a further digital watermark frame from at least one further frame of the plurality of frames of the video stream;
perform an elementwise XOR operation between a first subframe of the further digital watermark frame and a second subframe of the further digital watermark frame, to determine a further key matrix;
determine a further first matrix of a further pair of matrices of random bits and a further second matrix of the further pair of matrices of random bits based on the further key matrix, wherein the further key matrix is an elementwise XOR product of the further first matrix and the further second matrix;
perform an elementwise XOR operation between the further first matrix of the further pair of matrices of random bits and the first subframe of the further digital watermark frame, to obtain a further first plurality of candidate message bits; and
perform an elementwise XOR operation between the further second matrix of the further pair of matrices of random bits and the second subframe of the further digital watermark frame, to obtain a further second plurality of candidate message bits.

13. The apparatus of claim 10, wherein the processing circuitry is configured to determine the first matrix of the pair of matrices of random bits and the second matrix of the pair of matrices of random bits comprises the processing circuitry is configured to retrieve, based on the key matrix, from a data structure the pair of matrices of random bits or data for obtaining or generating the pair of matrices of random bits.

14. The apparatus of claim 13, wherein the processing circuitry is configured to perform the elementwise XOR operation between the first subframe of the digital watermark frame and the second subframe of the digital watermark frame, to determine the key matrix comprises the processing circuitry is configured to:
perform the elementwise XOR operation between the first subframe of the digital watermark frame and the second subframe of the digital watermark frame, to obtain a candidate key matrix; and
determine the key matrix based on the data structure by determining the key matrix defined by the data structure having a smallest distance to the candidate key matrix.

15. The method of claim 9, further comprising:
embedding the digital watermark frame in one or more frames of the plurality of frames of the video stream.

16. The method of claim 9, further comprising:
arranging at least one of the first subframe or the second subframe at more than one position of the digital watermark frame.

17. The method of claim 9, further comprising:
generating a first subframe of at least one further digital watermark frame, wherein the first subframe of the at least one further digital watermark frame is a result of an elementwise XOR operation between a first matrix of a further pair of matrices of random bits and the matrix of the plurality of message bits in the digital watermark frame; and
generating a second subframe of the at least one further digital watermark frame, wherein the second subframe of the at least one further digital watermark frame is a result of an elementwise XOR operation between a second matrix of the further pair of matrices of random bits and the matrix of the plurality of message bits in the digital watermark frame.

18. The method of claim 17, further comprising:
embedding the at least one further digital watermark frame in one or more further frames of the plurality of frames of the video stream.

19. The method of claim 17, further comprising:
storing in a data structure the pair of matrices of random bits together with a key matrix, or data for obtaining or generating the pair of matrices of random bits and the key matrix, wherein the key matrix is an elementwise XOR product of the first matrix of the pair of matrices of random bits and the second matrix of the pair of matrices of random bits.

20. The method of claim 9, further comprising:
generating the pair of matrices of random bits, including the first matrix of the pair of matrices of random bits and the second matrix of the pair of matrices of random bits.
